(19) United States
(12) Patent Application Publication
(10) Pub. No.: US 2021/0350778 A1
(43) Pub. Date: Nov. 11, 2021

(54) METHOD AND SYSTEM FOR PROCESSING AUDIO STEMS

(71) Applicant: ACCUSONUS, INC., Lexington, MA (US)

(72) Inventors: Elias KOKKINIS, Patras (GR); Lefteris KOTSONIS, Attica (GR); Alexandros TSILFIDIS, Athens (GR)

(21) Appl. No.: 17/282,876

(22) PCT Filed: Oct. 10, 2019
(86) PCT No.: PCT/US2019/055548

§ 371 Date: Apr. 5, 2021

Related U.S. Application Data
(60) Provisional application No. 62/743,680, filed on Oct. 10, 2018.

(51) Int. Cl. G10H 1/00

(52) U.S. Cl. CPC G10H 1/0025; G10H 2240/141; G10H 2210/125; G10H 2210/051

(57) ABSTRACT

A method and system for processing an audio stem/loop, including dividing a stem into a plurality of stem slices, classifying each of the plurality of stem slices into at least a first group or a second group and applying a stem effect, that includes replacing at least one stem slice with an all-zero stem slice, replacing at least one stem slice belonging to the first group or the second group with a stem slice belonging to the first group or the second group.

### CROSS REFERENCE TO RELATED APPLICATIONS

The present application claims the benefit of and priority under 35 U.S.C. § 119(e), to U.S. Provisional Application No. 62/743,680, filed Oct. 10, 2018, entitled “METHOD FOR PROCESSING AUDIO STEMS” which is incorporated herein by reference, in its entirety, for all that they teach and for all purposes.

### BACKGROUND

An important part of modern music production is the use of the samples. Samples are usually short audio files that contain some musical information. There are single shot samples that contain a single sound or loops that contain a short musical phrase that is performed typically by a single instrument (drums, guitar, bass, etc.) or sometimes two or more instruments. Loops are also call stems. An audio stem represents one or more audio sources mixed together. In the context of this technology we refer to loops and stems interchangeably.

Musicians and producers make heavy use of loops mainly in electronic music production. Percussive loops or beats form the rhythmic foundation of their tracks while melodic loops (e.g. guitar or piano loops) are used to create musical phrases. The main problem with the use of loops is that they are static, in the sense that they are audio files played back by a computer that are always the same. In contrast, when a musician plays a musical phrase with her instrument, it is dynamic, in the sense that it's never exactly the same. Electronic music producers are aware of this and go to great lengths to manually change the loop over time using advanced features of their Digital Audio Workstation (DAW) applications like automation. This process is very time-consuming and inefficient. Hence, there is a need for methods that produce loop variations automatically without user intervention or with minimal user intervention where she will setup one or a few parameters.

Because of the importance of loops in the modern music production workflow, there are several commercial libraries available. Musicians and producers typically have access to thousands of loops that they can use. There is a need for automatic methods that will automatically produce new variations of the loops inside the user libraries and hence allow users to re-use them for a very long time without being the same.

### SUMMARY

Aspects of the technology relate to processing an audio stem, including dividing a stem into a plurality of stem slices, classifying each of the plurality of stem slices into at least a first group or a second group and applying a stem effect.

Aspects of the technology relate to applying a stem effect comprising replacing at least one stem slice with an all-zero stem slice.

Aspects of the technology relate to applying a stem effect comprising replacing at least one stem slice belonging to the first group with a stem slice belonging to the second group.

Aspects of the technology relate to applying a stem effect comprising replacing at least one stem slice belonging to the second group with a stem slice belonging to the first group.

Aspects of the technology relate to applying a stem effect comprising replacing at least one stem slice belonging to the first group with a different stem slice belonging to the first group.

Aspects of the technology relate to applying a stem effect comprising replacing at least one stem slice belonging to the second group with a different stem slice belonging to the second group.

Aspects of the technology relate to applying a stem effect comprising replacing at least one stem slice with a time-reversed version of the at least one stem slice.

Aspects of the technology relate to applying a stem effect comprising replacing at least one stem slice by a time-reversed version of a second stem slice, wherein the second stem slice precedes the at least one stem slice.

Aspects of the technology relate to processing an audio stem, including dividing a stem into a plurality of stem slices, classifying each of the plurality of stem slices into at least a first group or a second group and applying a stem effect, wherein the first group is associated with a low energy level and the second group is associated with a high energy level.

Aspects of the technology relate to processing an audio stem, including dividing a stem into a plurality of stem slices, classifying each of the plurality of stem slices into at least a first group or a second group and applying a stem effect, wherein a stem effect comprises replacing at least one stem slice with a time-reversed version of the at least one stem slice and wherein the time-reversed version of the at least one stem slice belongs to the high energy group.

Aspects of the technology relate to processing an audio stem, including dividing a stem into a plurality of stem slices, classifying each of the plurality of stem slices into at least a first group or a second group and applying a stem effect, wherein a stem effect comprises replacing at least one stem slice with a time-reversed version of the at least one stem slice and wherein the time-reversed version of the at least one stem slice belongs to the low energy group.

Aspects of the technology relate to processing an audio stem, including dividing a stem into a plurality of stem slices, classifying each of the plurality of stem slices into at least a first group or a second group and applying a stem effect, wherein the stem effect comprises replacing at least one stem slice belonging to the first group with a different stem slice belonging to the first group, wherein the time-reversed version of the second stem slice belongs to the high energy group.

Aspects of the technology relate to processing an audio stem, including dividing a stem into a plurality of stem slices, classifying each of the plurality of stem slices into at least a first group or a second group and applying a stem effect, wherein the stem effect comprises replacing at least one stem slice belonging to the first group with a different stem slice belonging to the first group, wherein the time-reversed version of the second stem slice belongs to the low energy group.

Aspects of the technology relate to using a different audio property than the energy level for classifying stem slices into a first and second group. For example, the audio property could include one or more of the energy level, frequency content, sharpness, crest factor, and/or skewness of the stem slices and/or psychoacoustic features such as pitch, timbre, and/or loudness of the stem slices.

Aspects of the technology relate to using a Euclidean algorithm to determine which stem slices to replace.

Aspect of the technology relate to calculating the energy level of each stem slice of the plurality of stems, sorting each stem slice in ascending order or descending order or alternating order based on the energy level of each stem slice to create a sorted stem slice sequence, replacing the first n stems in the sorted stem slice sequence with an all-zero stem slice, wherein n is an integer greater 0.

Aspects of the technology relate to processing an audio stem, including dividing a stem into a plurality of stem slices, classifying each of the plurality of stem slices into at least a first group or a second group and applying a stem effect, wherein the first group is associated with high frequencies and the second group is associated with low frequencies.

Aspects of the technology relate to processing an audio stem, including dividing a stem into a plurality of stem slices, classifying each of the plurality of stem slices into at least a first group or a second group and applying a stem effect, wherein the first group and second groups are based on two or more different audio properties, wherein the audio properties include energy level and/or frequency content and/or sharpness and/or crest factor and/or skewness of the stem slices.

### BRIEF DESCRIPTION OF THE DRAWINGS

For a more complete understanding of the technology, reference is made to the following description and accompanying drawings, in which:

FIG. 1 illustrates the basic steps of the method for processing stems disclosed herein;

FIGS. 2A and 2B illustrates examples of dividing a stem in stem slices;

FIG. 3 illustrates the steps of an exemplary embodiment that performs stem slice grouping;

FIG. 4 illustrates the concept of the stem pattern vector;

FIG. 5 illustrates an exemplary embodiment of the “arrange” stem effect;

FIG. 6 illustrates an exemplary embodiment of stem pattern vector generation;

FIGS. 7A and 7B illustrates an embodiment of the “filter” stem effect with time-reversal;

FIG. 8 illustrates an embodiment of the “filter” stem effect with zero gain application; and

FIG. 9 illustrates an exemplary system for performing stem processing.

### DETAILED DESCRIPTION

Consider an audio signal x(k). For the purposes of the present disclosure we refer to this signal as an audio stem. We refer to x(k) as an audio signal or an audio stem interchangeably. It is understood that the present technology can be applied to any audio signal or audio stem(s) that contain any number of audio sources.

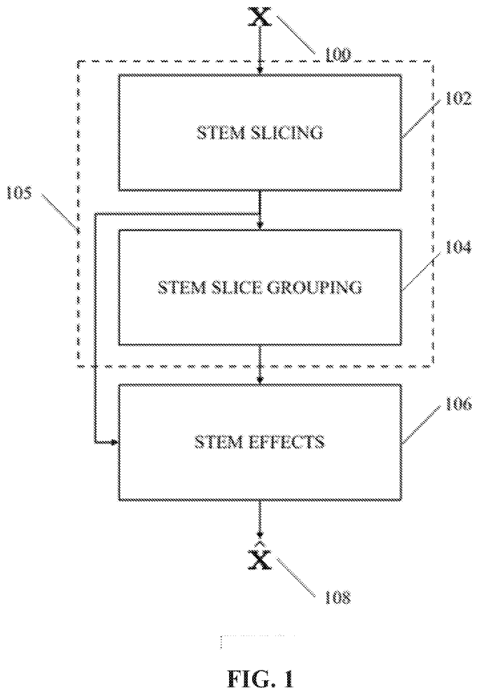

The present disclosure provides a method for processing audio stems to produce stem variations. The exemplary steps of the method are shown in FIG. 1. An input stem 100 is first divided in stem slices 102. The stem slices are analyzed to identify stem slices that are similar in some sense and similar slices are grouped 104 together. The stem slicing and stem slice grouping steps form a pre-processing step 105 for applying stem effects on the input stem. The result of preprocessing is used to apply one or more stem effects 106 and produce the variant audio stem 108.

The first step of the exemplary method is to divide a stem into stem slices or equivalently perform “stem slicing”. A stem slice represents a part of the audio signal and is an audio signal itself. The length of a stem slice is Nᵢ. Here a stem slice is represented as a Nᵢ×1 vector xᵢ. Each element of the vector corresponds to a sample of the audio signal x(k)

xᵢ=[x(N_{P}+1),x(N_{P}+2), . . . ,x(N_{P}+Nᵢ)]^{T} (1)

where N_{P}=Σₖ₌₀^{P}Nₖ. The index i of each stem slice indicates its order in the stem. This way writing

x=[x₁^{T},x₂^{T}, . . . ,x_{M}^{T}]^{T} (2)

we can represent the complete original audio signal. M is the number of slices and depends on the length of the stem and the method we choose to divide the stem into slices.

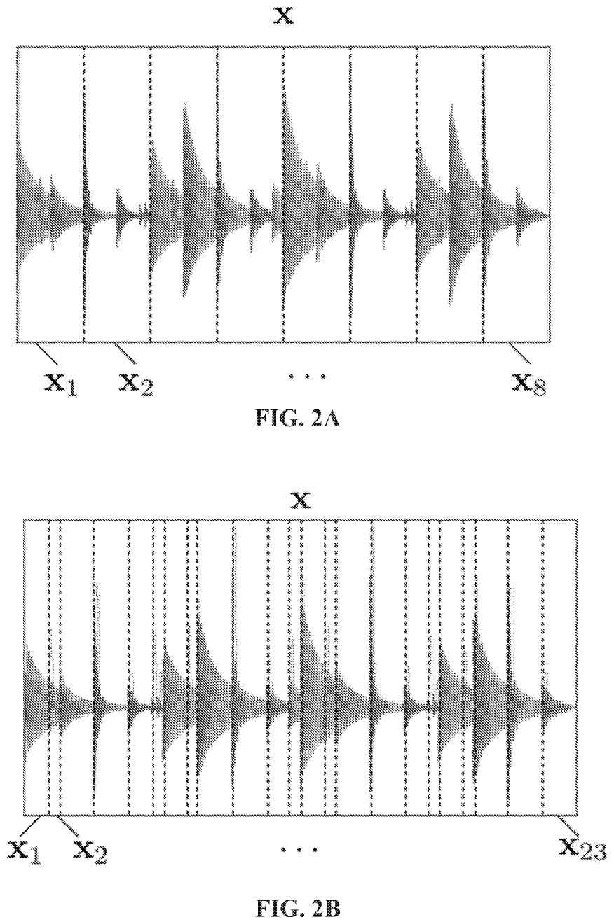

In one technique each stem slice corresponds to a musical note duration. This way we divide the stem in slices of equal musical length (e.g. a quarter note or a triplet sixteenth note). An example is shown in FIG. 2A where a stem is divided in stem slices of equal length. The stem has a duration of two bars and each slice has a duration of a quarter note resulting in M=8. In another embodiment each stem slice could have a length that corresponds to a different musical note.

In a third technique the start and end points of a slice and hence its length could be defined according to a detection function d(x). An example is shown in FIG. 2B. The stem here is the same as in FIG. 2A. With the dashed line the detection function is shown which in this example is an onset detection function. The stem has been divided in M=23 stem slices. The start and end of each stem slice is defined by the detection function.

After a stem is divided in stem slices, we group the stem slices together based on some measure of “similarity”. The goal here is that each stem slice group can be meaningfully interpreted in the context of music creation or synthesis to help design and implement useful stem effects. For each slice xᵢ we extract a F×1 feature vector fᵢ and create the F×M feature matrix S. The features we choose to extract define the concept of “similarity”.

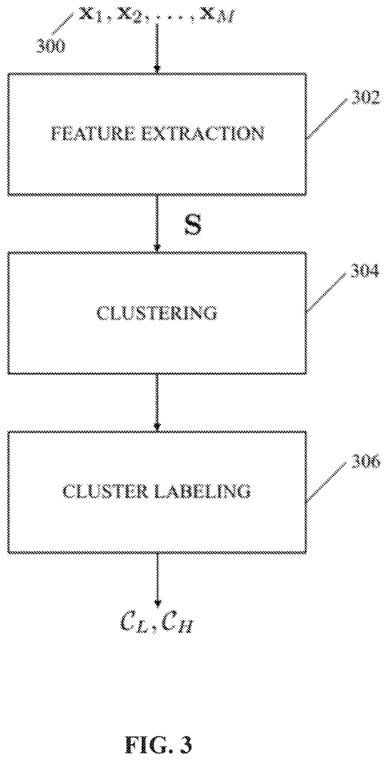

In one embodiment of this disclosure, we want to group stem slices according to how important they are to the rhythmic structure of the stem. In one exemplary embodiment we use the stem slice energy as an indication of its importance. We separate stem slices in groups with the following steps which are also shown in FIG. 3:
1. Calculate the energy of each stem slice 300. This is the feature extraction step 302.
2. Use a clustering method 304 on the feature matrix S to group slices in two clusters C₁ and C₂. In this exemplary embodiment the feature matrix boils down to a vector since only the energy feature is used.
3. Label the resulting clusters 306. This allows us to classify the stem slices in groups that have some meaning or interpretation in the context of the application. Here we calculate the room mean squared (RMS) amplitude of each stem slice and average these values for the slices of each cluster. The cluster with the lowest mean RMS amplitude is the “low energy” stem slice group C_{L}. The other cluster represents the “high energy” stem slice group C_{H}.

Alternatively, or in addition, stem slice groups can be based on two or more features including frequency content or other audio signal properties (such as sharpness, crest factor, skewness, etc.) or psychoacoustic features such as pitch, timbre, loudness.

One is not limited to create two stem slice groups. We can create a plurality of stem slice groups either directly or hierarchically. For example, after creating a high energy and a low energy group based on the energy level, the high energy group and/or the low energy group could each be further divided into a high frequency group and a low frequency group. This additional grouping is, of course, not limited to frequency and energy. Any two or more audio features/properties can be combined in this manner to create a plurality of stem slice groups. It is also understood that any clustering method can be used to produce the stem slice feature groups from the stem slice feature matrix S, including but not limited to k-means clustering, Gaussian Mixture Model (GMM) clustering, non-negative factorization (NMF) clustering, etc. Supervised classification methods can also be used to group stem slices according to the feature matrix S if sufficient training data are available, including but not limited to Support Vector Machines (SVM), artificial neural networks and deep neural networks (ANN, DNN), naïve Bayes classifiers, etc.

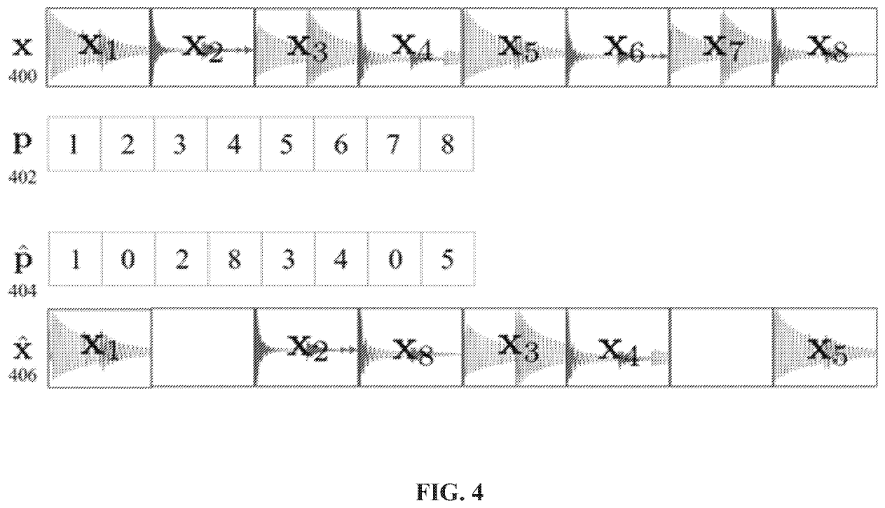

The final step as shown in FIG. 1 is the application of one or more stem effects 106. To describe the stem effects, we first need to define the stem pattern. The stem pattern is a M×1 vector p. The value of each vector element is a stem slice index. We can use a stem pattern vector to create variations of the original stem. If the stem pattern has not changed and the stem slices have not been processed the result is the original stem. Zero values in the stem pattern vector indicate that no stem slice is used and correspondingly an all-zero slice is generated and placed in the stem. An example is shown in FIG. 4. The original stem x 400 is divided to M=8 stem slices as in FIG. 2A. The corresponding pattern vector p is 402. A new pattern vector \hat{p} 404 can be the result of a stem effect or any other process. We can use this vector to generate a new stem \hat{x} 406. In this example, based on pattern vector \hat{p} 404 x₂ and x₇ is replaced by the all-zero slice, x₃ is replaced by x₇, x₄ is replaced by x₈, x₅ is replaced by x₃, x₆ is replaced by x₄, x₈ is replaced by x₄, x₁ is not changed.

A stem effect is a process that generates a new pattern vector and/or applies some processing on one or more stem slices to produce a new stem variation. A stem effect can have one or more parameters that control the behavior of the effect. We will describe several stem effects in the following paragraphs.

A stem effect that is very useful in music creation or synthesis is the “arrange” effect. “Arrange” is a stem effect that can produce slight or drastic variations of a stem, similar to those of a human musician when performing a musical phrase. To apply this effect to a stem, we generate a new pattern vector \hat{p} using an M×M permutation matrix T

\hat{p}=Tp (3)

and then use this pattern vector to generate the stem variation as in FIG. 4. The method used to construct the permutation matrix T is important and needs to provide pattern vectors that are musically meaningful. A simple random permutation matrix won't suffice. One exemplary technique is that we can use information from the stem slice groups to construct permutation matrices that are suitable for producing stem variations that can be used in music creation and synthesis.

We describe here an exemplary step by step process to construct the permutation matrix T.
1. Start with T=I, where I is the identity matrix.
2. Randomly select a row tₘ. The row index m is chosen from Ω_{M}={m∈ [symbol] : m≤M}.
3. Generate a 1×M replacement vector r. A replacement vector has elements r_{c}=0 for c∈Ω_{M}, c≠c*. The index c* defines the index of the stem slice that will replace the m-th slice chosen in step 2 and r_{c*}=1. To generate musically meaningful replacements we choose values for c* from a specific stem slice group. Note here that the stem slice groups index sets satisfy C_{L}⊂Ω_{M}, C_{H}⊂Ω_{M}. There are several strategies that one can think on how to construct the replacement vector, including but not limited to:
   a. In one embodiment, we want to replace stem slices only with high energy slices to produce variations of the stem that are more “busy”. Hence we randomly choose a value c*∈C_{H}.
   b. In another embodiment, we randomly choose the value of c* depending the group that the m-th slice belongs. For example, if m∈C_{L} then we choose a random value so that c*∈C_{H}. Alternatively or in addition, for example, if m C_{H} then we choose a random value of c*∈C_{L}.
   c. In a third embodiment, the value of an effect control parameter value is used to decide how the index value c* is chosen.
4. Replace tₘ with r.

We can repeat steps 2-4 if needed. As an option, a parameter v can define how many times the process is repeated. For example, if v=1 we repeat the process one time, if v=2 we repeat the process twice and so on and so forth. This parameter may be set by a user or it can depend on other parameters of other stem effects. In this case the maximum value of this parameter is equal to the number of slices.

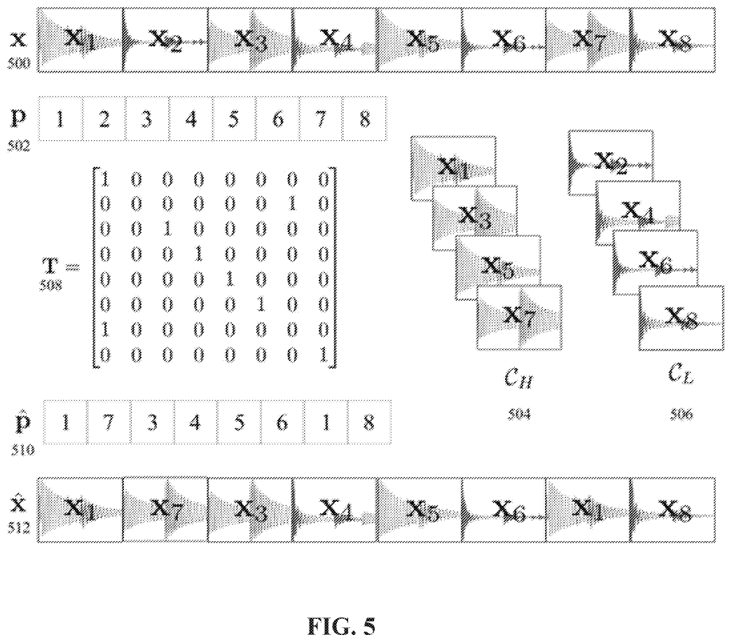

An example of the “arrange” stem effect is shown in FIG. 5. The same stem and stem slices 500 as in FIG. 2A is used. For a stem effect parameter value v=2 we construct the permutation matrix T 508. In step 2, the row 2 was randomly chosen. Using step 3 the stem slice index 7 was randomly chosen from C_{H}. Since v=2 we repeat the process and row 7 was randomly chosen and stem slice index 1 was randomly chosen from C_{H}. Applying this permutation matrix to the original pattern vectors in (3) results in the new pattern vector \hat{p} 510. According to this pattern vector we construct the variant stem \hat{x} 512.

Instead of starting from an existing pattern vector p and generating new ones via permutation matrices, we can choose to directly generate a new pattern vector and use the stem slices to produce radical variations of the original stem. There are two main questions here: a) How to generate a completely new pattern vector p and b) how to choose the stem slices that will be used to produce the stem variation.

In one embodiment, we use the Euclidean algorithm to produce stem variations employing the following steps:
1. Generate a pattern vector p=EUC(v, M), where v is the stem effect parameter and M is the number of slices.
2. For the elements of pⱼ=1 we choose a random stem slice from C_{H}.
3. For the elements of pⱼ=0 we can choose one of the following:
   a. Use a stem slice with zero elements.
   b. Choose a random stem slice from C_{L}.

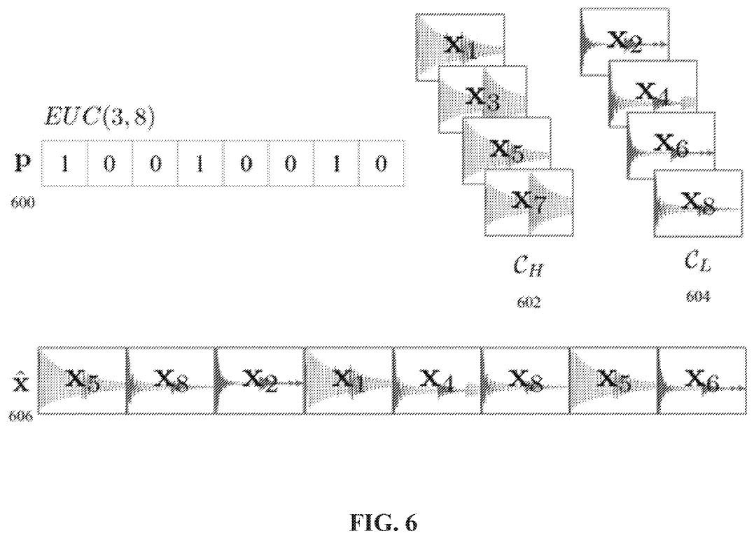

Using this method, we can product stem variations that have consistent sonic characteristics but radically different rhythmic structures. An example is shown in FIG. 6. The same stem as in FIG. 2A, FIG. 2B and FIG. 4 is used and divided into M=8 stem slices. The stem slices have been grouped in a high energy group C_{H} 602 and a low energy group C_{L} 604. For a parameter value v=3 the generated pattern vector p=EUC(3, 8) is shown in 600. Following the steps described above the variant stem \hat{x} 606 is produced.

Another stem effect that is very useful to produce stem variations that are musically meaningful is the “filter” effect. The “filter” effect defines a processing function ƒ(x) that will process one or more of the stem slices. It is understood that ƒ(x) can describe any type of processing including but not limited to filtering, time-reversal, amplitude modification, dynamic range compression, saturation, pitch shifting, etc. The type of processing can be user defined or chosen depending on the properties of a stem slice. Again, the main issue here is how many and which stem slices will be chosen to apply the processing. We use the stem slice groups to choose slices and apply processing that will result in musically meaningful stem variations.

In one embodiment of the generic type of “filter” stem effect we define the “reverse” effect where the processing function ƒ(x) applies a time-reversal on the stem slice data. We define the Nᵢ×Nᵢ exchange matrix E and the time-reversed slice is [symbol] ᵢ=Exᵢ. To apply this effect we perform the following steps:
1. We want the time-reversal to be noticeable and exciting. Hence, we want to apply it to high energy slices. We randomly choose a slice index i∈C_{H}.
2. Apply the exchange matrix E to produce the time reversed slice [symbol] ᵢ.
3. Choose one of the following:
   a. Replace xᵢ with [symbol] ᵢ in (1).
   b. Replace xᵢ₊₁ with [symbol] ᵢ in (1).

If rhythmic structure of the original stem is important and should be kept intact, we can use step 3b. This way the i-th high energy slice remains in place, unprocessed and is followed by a time-reversed copy of itself.

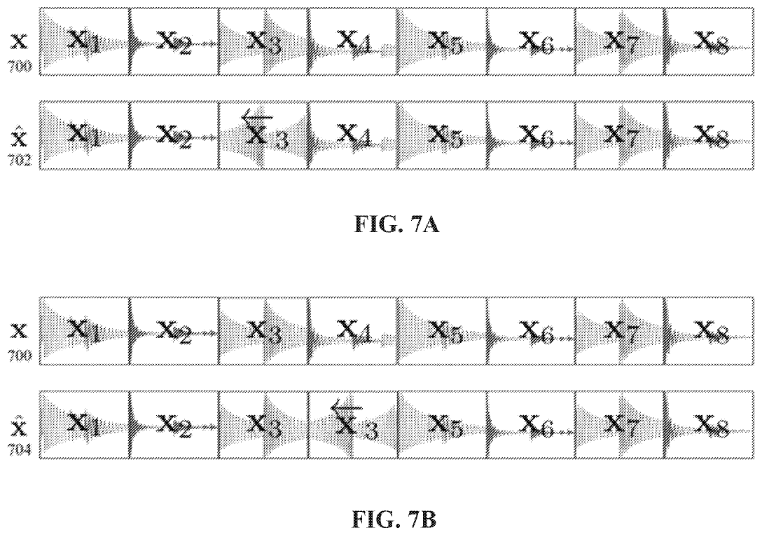

An example of using step 3a is shown in the FIG. 7A. Again we use the same stem as in FIG. 2A namely 700. We assume i=3 was randomly chosen in step 1. Then after applying step 2 and step 3a we produce the stem variant \hat{x} 702. In this example, x₃ is replaced by a time-reversed version of itself [symbol] ₃.

An example of using step 3b is shown in the FIG. 7B. Again we use the same stem as in FIG. 2A namely 700. We assume i=3 was randomly chosen in step 1. Then after applying step 2 and step 3b we produce the stem variant \hat{x} 704. In this example, x₄ is replaced by a time reversed version of the previous stem slice [symbol] ₃.

Steps 1-3 can be repeated a number of times. As with the “arrange” effect, a parameter v can define how many times the process is repeated. For example if v=1 we repeat the process one time, if v=2 we repeat the process twice and so on and so forth. This parameter may be set by a user or it can depend on other parameters of other stem effects. In this case the maximum value of this parameter is equal to the number of slices in C_{H}.

In another embodiment of the “filter” stem effect, we define the “silence” effect where the processing function ƒ(x) applies a zero gain value to the stem slice data. This effect will produce stem variations that are more sparse and leave space in order to use the stem with other stems in a music creation or synthesis scenario. As we discussed before, the choice of which slices to process is not trivial. To obtain a musically meaningful stem variation when applying the silence effect we perform the following steps:
1. Calculate the energy of each stem slice xᵢ.
2. Sort the stem slice index values i in ascending order according to the respective energy values of step 1.
3. Define a parameter v with integer values and a maximum value equal to the number of stem slices M.
4. Choose the first v stem slice indices from the ordered values of step 2.
5. Apply the zero gain the stem slices corresponding to the indices chosen in step 4.
6. Replace these stem slices in (1).

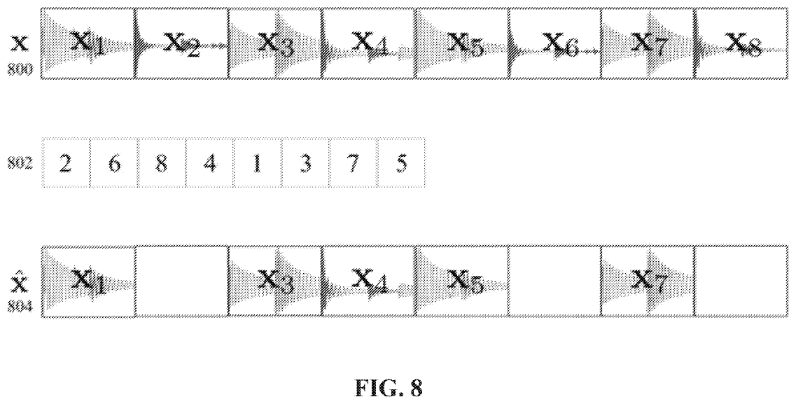

Of course, we can use different sorting orders in step 2 including but not limited to descending, alternating, etc. An example is shown in FIG. 8. We use the same original stem and stem slices as in FIG. 2A. After steps 1, 2 the sorted stem slice index vector for this example is 802. Let the stem effect parameter value be v=3. The resulting stem variant vector \hat{x} 804 has slices 2, 6 and 8 that have zero samples according to step 5 and 6.

One exemplary goal behind the “arrange” and “filter” effects as detailed above is that they are “guided” by the properties of the stem slices as defined in the stem slice grouping. This allows us to define stem effects that achieve specific musical results depending on the features we use in the stem slice grouping and how we use the groups to constrain the construction of permutation matrices or choosing slices to apply processing. While we have described embodiments of the “arrange” and “filter” effects that use a stem slice grouping with two groups, it is understood that one can devise generalizations with three or more groups. It is also understood, that we can combine a number of processing functions ƒ(x) to define more complex effects. For example, we can define two different processing functions ƒ₁(x), ƒ₂(x) and apply each function only to stem slices from a specific group, for example use ƒ₁(x) to process the stem slices from C_{L} and ƒ₂(x) to process the stem slices from C_{H}.

We can combine the steps and principles defined for the “arrange” and “filter” effects and create any process that produces musically meaningful stem variations.

We are not limited to the number of stem effects that are applied on a stem. We can choose to apply two or more effects to the stem, in series or in parallel or in any combination of these. The order of the application of effects can be predefined, user defined or automatically determined based on some properties of the stem. One important issue if we will perform a pre-processing (i.e. stem slice grouping) step before each stem effect to choose different stem slicing methods or to update the stem slice groups for the new stem variant. However, at least one preprocessing step must be performed before applying the first stem effect.

Users have often access to multiple stems from the same song for example the vocal stem, the percussion stem, the bass stem and the guitar stem. Alternatively, we can use source separation methods to automatically extract multiple stems from an existing stem or song.

When multiple stems are present, we can choose to apply any number of stem effects in each of the stems. The number and type of the stem effects applied on each stem can be different or the same for some or all stems. In the case of multiple stems, one or more global parameters can be defined that control the value of individual stem effect parameters. The global parameters can control the same stem effect parameter for all stems or different stem effect parameters for each stem.

While the above-described embodiments have been discussed in relation to a particular sequence of events, it should be appreciated that changes to this sequence can occur without materially effecting the operation of the technology. Additionally, the exemplary techniques illustrated herein are not limited to the specifically illustrated embodiments but can also be utilized and combined with any one or more of the other exemplary embodiments and each described feature is individually and separately claimable.

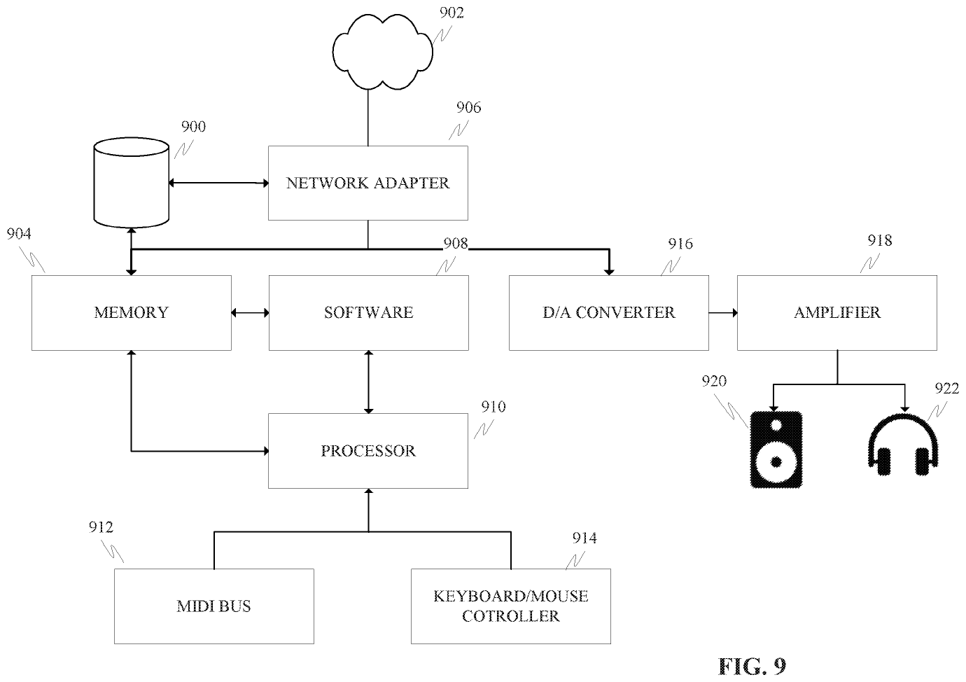

An exemplary embodiment of a system for processing stems is shown in FIG. 9. The system includes a file system 900 where audio files are stored. Additionally, the system can have access to a cloud storage 902 via a network adapter 906 which provides access to a local network and/or the Internet. At least one audio file from the file system 900 or the cloud storage 902 is loaded in the system memory 904. An audio file here corresponds to a loop or audio stem. The software 908 can read the data of the audio stem in memory 904 and can cause to be performed any of the methods above, using instructions for the processor 910. The software 908 will write the resulting audio stem variant in memory 904. A digital to analog (D/A) converter 914 can read this data and create an analog audio signal which can be amplified 918 and finally drive a pair of headphones 922 or a set of loudspeakers 920 which the user employs to listen to the result of the stem effects. The audio stem variant can also be written from memory to the local file system or the cloud storage. Additionally, the system has a MIDI bus 910 which can receive MIDI messages from an external MIDI device to control the stem effects implemented by the software. The system also has a keyboard and mouse controller 912 to communicate with keyboard and/or mouse devices which the user can employ together with the MIDI device or separately to control the stem effects and other aspects of the system.

Additionally, the systems, methods and protocols of this technology can be implemented on a special purpose computer, a programmed micro-processor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, any comparable means, or the like. In general, any device capable of implementing a state machine that is in turn capable of implementing the methodology illustrated herein can be used to implement the various methods, protocols and techniques according to this disclosure.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-835032 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed methods may be readily implemented in software on an embedded processor, a micro-processor or a digital signal processor. The implementation may utilize either fixed-point or floating point operations or both. In the case of fixed point operations, approximations may be used for certain mathematical operations such as logarithms, exponentials, etc. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized. The systems and methods illustrated herein can be readily implemented in hardware and/or software using any known or later developed systems or structures, devices and/or software by those of ordinary skill in the applicable art from the functional description provided herein and with a general basic knowledge of the audio processing arts.

Moreover, the disclosed methods may be readily implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated system or system component, or the like. The system can also be implemented by physically incorporating the system and/or method into a software and/or hardware system, such as the hardware and software systems of an electronic device.

Any non-transitory computer-readable information storage media, having stored thereon instructions, that can be executed by one or more processors and cause to be performed the methods described above.

Finally, the disclosed methods may be readily implemented as services or applications accessible from the user via a web browser. The software can reside in a local server or a remote server. The software may be written in JavaScript utilizing JavaScript Web APIs such as the Web Audio API or make use of Web Assembly.

It is therefore apparent that there has been provided, in accordance with the present disclosure, systems and methods of processing audio stems. While this technology has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this disclosure.

1. A method of processing an audio stem, the method comprising:
dividing a stem into a plurality of stem slices;
classifying each of the plurality of stem slices into at least a first group or a second group;
applying a stem effect, wherein the stem effect comprises replacing at least one stem slice with another stem slice; and
outputting an updated stem.

2. The method of claim 1, wherein the first group is associated with a high energy level and the second group is associated with a low energy level.

3. The method claim 1, further comprising replacing the at least one stem slice belonging to the first group with a different stem slice belonging to the first group.

4. The method claim 1, further comprising replacing the at least one stem slice belonging to the second group with a different stem slice belonging to the second group.

5. The method claim 1, further comprising replacing the at least stem slice with and all-zero stem slice.

6. The method claim 1, further comprising replacing the at least one stem slice belonging to the first group with a stem slice belonging to the second group.

7. The method claim 1, further comprising replacing the at least one stem slice belonging to the second group with a stem slice belonging to the first group.

8. The method claim 1, further comprising replacing the at least one stem slice with a time-reversed version of the at least one stem slice.

9. The method claim 1, further comprising replacing the at least one stem slice by a time-reversed version of a second stem slice, wherein the second stem slice precedes the at least one stem slice.

10. The method of claim 8, wherein the time-reversed version of the at least one stem slice belongs to the first group.

11. The method of claim 8, wherein the time-reversed version of the at least one stem slice belongs to the first group.

12. The method of claim 9, wherein the time-reversed version of the second stem slice belongs to the first group.

14. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. The method of claim 9, wherein the time-reversed version of the second stem slice belongs to the second group.

27. The method of claim 1, wherein the first group and second group are determined based on an audio property, wherein the audio property is the frequency content, sharpness, crest factor, or skewness of the stem slices.

28. The method of claim 1, wherein the first group and second groups are determined based on two or more different audio properties, wherein the audio properties include energy level and/or frequency content and/or sharpness and/or crest factor and/or skewness of the stem slices.

29. The method of claim 1, further comprising calculating the energy level of each stem slice of the plurality of stems, sorting each stem slice in ascending order or descending order or alternating order based on the energy level of each stem slice to create a sorted stem slice sequence, replacing the first n stems in the sorted stem slice sequence with an all-zero stem slice, wherein n is an integer greater 0.

30. The method of claim 1, further comprising using a Euclidean algorithm to determine which stem slice to replace.

31. A non-transitory computer-readable information storage media, having stored thereon instructions, that when executed by one or more processors, causes to be performed the method comprising:
dividing a stem into a plurality of stem slices;
classifying each of the plurality of stem slices into at least a first group or a second group;
applying a stem effect, wherein the stem effect comprises replacing at least one stem slice with another stem slice; and
outputting an updated stem.

32. An audio processing system comprising:
a memory storing instructions, and processing circuitry coupled to the memory, the processing circuitry to implement a method comprising:
dividing a stem into a plurality of stem slices;
classifying each of the plurality of stem slices into at least a first group or a second group;
applying a stem effect, wherein the stem effect comprises replacing at least one stem slice with another stem slice; and
outputting an updated stem.

33. The audio processing system of claim 32, further comprising a digital signal processor.

34. The audio processing system of claim 32, further comprising a D/A converter.

35. The audio processing system of claim 32, further comprising a network adapter.

36. The audio processing system of claim 32, further comprising one or more input devices.

37. The audio s processing system of claim 32, further comprising one or more of a MIDI bus, an amplifier, storage, speakers and/or headphones that receive/play the output stem.
